(19) United States
(12) Patent Application Publication
(10) Pub. No.: US 2017/0193421 A1
(43) Pub. Date: Jul. 6, 2017

(54) WORK FLOW SCHEDULE RECONCILIATION AND DATA PUSH

(71) Applicant: Bank of America Corporation, Charlotte, NC (US)

(72) Inventors: Alicia C. Jones-McFadden, Fort Mill, SC (US); Matthew Hsieh, Charlotte, NC (US); Gail Mohr, Menlo Park, CA (US); Linda Yoon Lentz, San Jose, CA (US)

(21) Appl. No.: 14/987,042

(22) Filed: Jan. 4, 2016

(51) Int. Cl. G06Q 10/06; H04L 29/08; H04W 4/02; G06Q 10/10; G06Q 10/02

(52) U.S. Cl. CPC G06Q 10/063112; G06Q 10/1095; G06Q 10/02; H04W 4/023; H04L 67/26

(57) ABSTRACT

Systems, methods, and computer program products are described herein that provide for identifying a need of a customer and providing selectable specialist meeting reservations with the customer based on the overall work-flow of an entity's offices, and the availability of relevant specialists that can address the need of the customer.

### FIELD OF THE INVENTION

This disclosure generally relates to work flow schedule reconciliation and data push.

### BACKGROUND

Planning for work load across multiple offices is a challenging task for an entity due to complexities of customer traffic levels at each office, types of specialists assigned to each office to handle customer needs, and the work flow schedules of these specialists. Typically, customers of the entity visit the closest offices to handle regularly occurring needs, and are unaware of the current customer traffic level at those offices or the expected wait times for a customer to see a specialist. As such, most customers would prefer to receive notifications and reservations to meet with a certain specialist at a date, time, and office location that is available for a specialist and convenient for the customer. Therefore, a need exists to identify a need of a customer provide selectable specialist meeting reservations with the customer based on the overall work-flow of an entity's offices, and the availability of relevant specialists that can address the need of the customer.

### SUMMARY OF INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for identifying a need of a customer and providing selectable specialist meeting reservations with the customer based on the overall work-flow of an entity's offices, and the availability of relevant specialists that can address the need of the customer. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention comprise providing a computing system comprising a computer processing device and a non-transitory computer readable medium, where the computer readable medium comprises configured computer program instruction code, such that when said instruction code operated by said computer processing device, said computer processing device performing certain operations to carry out the invention.

For sample, illustrative purposes, system environments will be summarized. The system may involve identifying a customer in a first geographical region and determining a need of the customer based on customer information stored in a customer information database. Additionally, the system may include determining a type of specialist associated with the need of the customer and identifying a plurality of offices in the first geographical region that employ one or more specialists of the type of specialist associated with the need based on office information stored in an office information database. In some embodiments, the system compares an availability of each of the one or more specialists to an availability of the customer, and matches a first specialist of the one or more specialists with the customer. Furthermore, the system may prompt a mobile device of the customer to display one or more selectable meeting reservation schedules between the customer and the first specialist. The system may then receive, from the mobile device of the customer, an indication that the customer selected a first meeting reservation of the one or more selectable meeting reservation schedules. The system may then establish the first meeting reservation between the customer and the first specialist at a first office of the plurality of offices that is associated with the first specialist.

In some embodiments of the system, the need of the customer is normally addressed by the customer on a first day of the week, but the system matches the customer and the first specialist in a meeting reservation that is for a second day of the week.

For some embodiments of the system, matching the first specialist comprises matching the customer to the first specialist based on at least one of the following factors: a closeness of a geographical location of the first office to a current geographical location of the customer; a closeness of the geographical location of the first office to a geographical location of a home of the customer; a closeness of the geographical location of the first office to a geographical location of a work place of the customer; a least amount of expected traffic at the first office, relative to expected traffic at the plurality of offices; and a least amount of scheduled meeting reservations for the first specialist, relative to the amount of scheduled reservations for the one or more specialists.

In some embodiments of the system, the customer information comprises at least one of the following: a calendar for scheduling appointments of the customer; transaction history of the customer; financial accounts of the customer; a geographical location of the customer; a geographical location of a home of the customer; a geographical location of a work site of the customer; and customer habits. In some embodiments, customer habits comprise common dates and times for the customer to visit the plurality of offices and/or common interactions between the customer and the one or more specialists.

For some embodiments of the system, office information comprises at least one of the following: a list of the one or more specialists; a calendar for scheduling appointments for each of the one or more specialists; historical traffic for each of the plurality of offices; hours of operation for each of the plurality of offices; and a geographical location of each of the plurality of offices.

The system may also include prompting a specialist device to display information associated with the need at the time and date associated with the first reservation. In some such embodiments, the information associated with the need of the customer comprises the customer information, the need of the customer, and/or a document associated with the need of the customer.

To the accomplishment of the foregoing and related objectives, the embodiments of the present invention comprise the function and features hereinafter described. The following description and the referenced figures set forth a detailed description of the present invention, including certain illustrative examples of the one or more embodiments. The functions and features described herein are indicative, however, of but a few of the various ways in which the principles of the present invention may be implemented and used and, thus, this description is intended to include all such embodiments and their equivalents.

The features, functions, and advantages that have been discussed may be achieved independently in various embodiments of the invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of a system environment for work flow schedule reconciliation and data push for an entity, in accordance with an embodiment of the invention;

FIG. 2 is a block diagram of a system environment for work flow schedule reconciliation and data push for an entity, in accordance with an embodiment of the invention; and

FIG. 3 is a general process flow for work flow schedule reconciliation and data push for an entity, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Various embodiments or features will be presented in terms of systems that may include a number of devices, components, modules, and the like. It is to be understood and appreciated that the various systems may include additional devices, components, modules, and the like, and/or may not include all of the devices, components, modules, and the like, discussed in connection with the figures. A combination of these approaches may also be used.

A “system environment,” as used herein, may refer to any information technology platform of an enterprise (e.g., a national or multi-national corporation), and may include a multitude of servers, machines, mainframes, personal computers, network devices, front and back end systems, database systems and/or the like.

As used herein, an “entity” may be any business, organization, or individual that owns, operates, or is otherwise associated with a federated authentication system. Although some embodiments of the invention described herein are generally described as involving an “entity,” other embodiments of the invention may involve business institutions that take the place of or work in conjunction with the entity.

As used herein, the term “customer” refers to an individual associated with the entity, such that the entity provides goods and/or services to the customer. As used herein, the term “specialist” refers to a person who is affiliated with an entity herein defined and is specially trained to handle a particular aspect of a business process of the entity.

Thus, systems, methods, and computer program products are described herein that provide for identifying a need of a customer provide selectable specialist meeting reservations with the customer based on the overall work-flow of an entity's offices, and the availability of relevant specialists that can address the need of the customer.

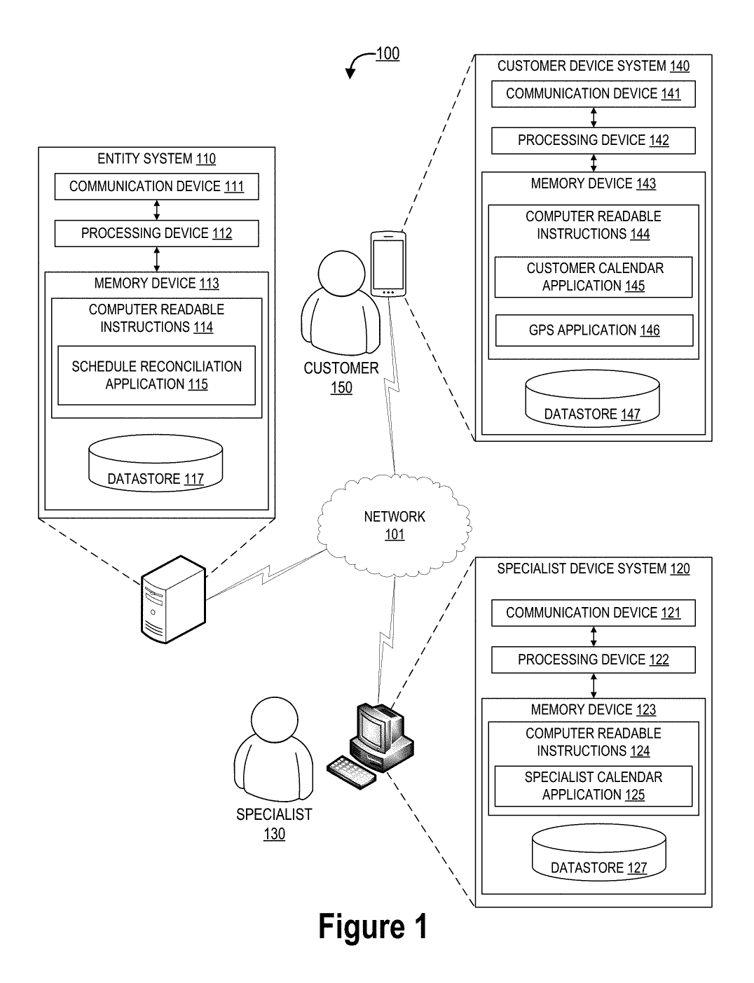

Referring now to FIG. 1, a block diagram of a system environment 100 is provided, which includes an entity system 110, a specialist device system 120 associated with a specialist 130, a customer device system 140 associated with a customer 150, and a network 101. The entity system 110, the specialist device system 120, and the customer device system 140 communicate with one another over the network 101. In some embodiments, the entity system 110 may establish an electronic communication link across the network 101 with the specialist device system 120 and the customer device system 140, such that data and notifications can be communicate through communication channels between two or more of the devices associated with the systems 110, 120, and 140.

As shown in FIG. 1, the entity system 110 includes a communication device 111, at least one processing device 112, and at least one memory device 113, in communication with the processing device 112. The memory device 113 contains computer readable instructions 114 including a schedule reconciliation application 115. Additionally, the memory device 113 includes a datastore 117 for storing schedule reconciliation data, customer 150 information data, specialist 130 information data, and/or office information data associated with the entity.

The specialist device system 120 includes a communication device 121 a processing device 122, and at least one memory device 123, in communication with the processing device 122. The memory device 123 contains computer readable instructions 124 including a specialist calendar application 125. Additionally, the memory device 123 includes a datastore 127 for storing schedule reconciliation data, customer 150 information data, specialist 130 information data, and/or office information data associated with the entity. The specialist device system 120 can be one or more personal computers, electronic notebooks, desktops, mobile device, or any computing device having network capability and in communication with the entity system 110 and the customer device system 140 through the network 101. In some embodiments, the computing devices of the specialist device system 120 may be one or more specialized computing devices that perform specific functions of the invention as described herein.

In some cases, a specialist interface is provided by the entity and can be installed on the specialist device system 120, as part of a specialist-side application, which, as shown in FIG. 1, is the specialist calendar application 125, also provided by the entity. The specialist interface can be launched by running the specialist calendar application 125 that communicates with the entity system 110 and the customer device system 140 via the network 101. In some embodiments, the specialist interface is part of a server-side specialist calendar application 125, built on the entity system 110, and can be presented to the specialist through a web browser by invoking the server-side application. A specialist-side application generally means that the application is stored and executed on the specialist's computer; while a server-side application means that the application runs on a server's computer, which, in the present incident, is the entity system 110 that communicates with the specialist device system 120 through the network 101.

The customer device system 140 includes a communication device 141 a processing device 142, and at least one memory device 143, in communication with the processing device 142. The memory device 143 contains computer readable instructions 144 including a customer calendar application 145 and a global positioning system (GPS) application 146. Additionally, the memory device 143 includes a datastore 147 for storing schedule reconciliation data, customer 150 information data, specialist 130 information data, and/or office information data associated with the entity. The customer device system 140 can be one or more personal computers, electronic notebooks, desktops, mobile device, or any computing device having network capability and in communication with the entity system 110 and the customer device system 140 through the network 101.

As used herein, the processing devices 112, 122, and 142 include circuitry for executing the functions of the entity system 110, the specialist device system 120, and the customer device system 140. For example, each of the processing devices 112, 122, and 142 can include a digital signal processor device, a microprocessor device, and various analog-to-digital converters, digital-to-analog converters, and other support circuits. Control and signal processing functions of the entity system 110, the specialist device system 120, and the customer device system 140, in which the processing devices 112, 122, and 142 reside, may be allocated between these devices according to their respective capabilities. The processing devices 112, 122, and 142 also include functionality to operate one or more software programs based on computer-executable program code portions thereof, which may be stored, along with the computer readable instructions 114, 124, in the memory devices 113, 123 on the entity system 110, the specialist device system 120, and the customer device system 140.

The memory devices 113, 123, and 143, as described herein, store the computer readable instructions 114, 124, and 144 and the datastores 117, 127, and 147. In some embodiments, the memory devices 113, 123, and 143 may include volatile memory, such as RAM having a cache area for the temporary storage of information. The memory devices 113, 123, and 143 may also include non-volatile memory that may be embedded and/or removable. The non-volatile memory may additionally or alternatively include an Electrically Erasable Programmable Read-Only Memory (EEPROM), flash memory, and/or the like. The memory devices 113, 123, and 143 can store any information and data that are used and administrated by the entity system 110, the specialist device system 120, and the customer device system 140 to implement the functions thereof.

In some embodiments, the schedule reconciliation application 115 is configured for communicating with the datastore 117 of the entity system 110, the customer device system 140 associated with the customer 150, the specialist device system 120 associated with one or more specialists 130 to schedule meetings between customers like customer 150 and a specialist of the entity like specialist 130.

The specialist 130 may interact with the specialist calendar application 125 of the specialist device system 120 to schedule meetings with customers (e.g., customer 150) of the entity. In this manner, the specialist calendar application 125 may provide calendar and scheduling features on a computing device associated with the specialist, and may display information related to customers to enable the specialist 130 to address needs of the customers.

In order for the entity to interact with the customer 150, the customer calendar application 145 of the customer device system 140 may control an input/output display interface for a computing device of the customer 150. The customer calendar application 145 may store information associated with one or more schedules of the customer 150, present scheduling information on the display of a computing device of the customer 150, receive input from a computing device of the customer 150 (e.g., via a keypad, microphone, touchscreen, and the like), and the like.

In some embodiments, the GPS application 146 of the customer device system 140 is configured to communicate with satellite systems to determine geographical location information associated with a mobile computing device associated with the customer 150. The GPS application 146 may store information in the datastore 147 such that the entity system 110 and/or the specialist device system 120 may retrieve geographical information associated with the mobile device of the customer 150.

The entity system 110, the specialist device system 120, and the customer device system 140, are each operatively connected to the network 101 and communicate with one another there through. The network 101 can include various networking interfaces, such as a local area network (LAN), a wide area network (WAN), a global area network (GAN), such as Internet, or a hybrid thereof. The network 101 may be secure or unsecure and may also include wireless and/or wireline and/or optical interconnection technology.

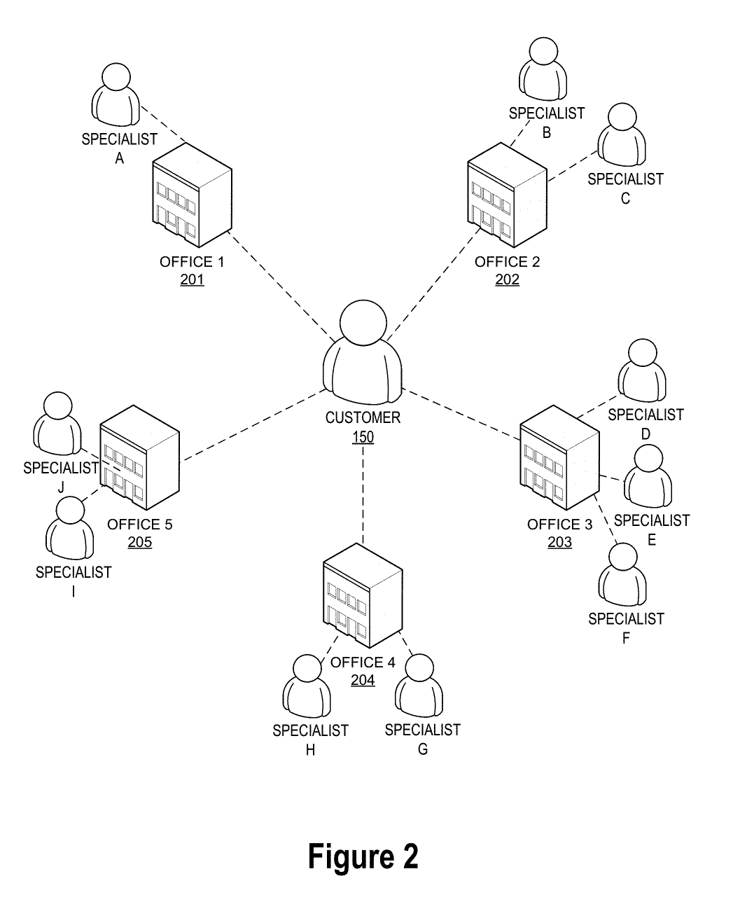

FIG. 2 illustrates a system environment 200 for work flow schedule reconciliation and data push, associated with a customer 150 and a plurality of offices 201-205 located in a geographical region. As shown in FIG. 2, the system identifies the customer 150 within the geographical region and identifies a plurality of offices 201-205 that are owned or operated by the entity and are also located in that geographical region. The system may also identify a plurality of specialists (i.e., Specialist A-Specialist J) that are associated with each office. For example, Office 1 is associated with Specialist A; Office 2 is associated with Specialist B and Specialist C; Office 3 is associated with Specialist D, Specialist E, and Specialist F; Office 4 is associated with Specialist G and Specialist H; and Office 5 is associated with Specialist I and Specialist J. Each specialist has expertise in one or more aspects of the entity's business, and different offices may be associated with specialists comprising the same and/or different expertise.

Additionally, each specialist may be authorized or tasked with addressing one or more needs of the customer 150 that relate to the business of the entity. For example, the entity may be a financial institution, and each office (i.e., Offices 1-5) is an office location of the financial entity. In such embodiments, the customer 150 may have one or more financial accounts at the financial institution and is able to access each office to resolve needs of the customer related to the financial accounts. For example, the customer may have a need of changing a named beneficiary of a financial account. The system may review the expertise of each specialist in the system environment 200 and determine that Specialist A, Specialist D and Specialist G have an expertise related to changing a named beneficiary for a financial account. The system may then analyze scheduling information related to each of Specialist A, Specialist D, and Specialist G, as well as information related to the respective office locations of Office 1, Office 3, and Office 4. Examples of office information include, but are not limited to, calendars for scheduling appointments for each associated specialist, historical traffic for each office, hours of operation for each office, and a geographical location of each of the plurality of offices.

The system may compare this office information for Office 1, Office 3, and Office 4 with customer information received or deduced from the customer 150 to match the customer with one of the Specialists A, D, and G. The match may be determined based on a number of factors including, but not limited to, a closeness of the geographical location of the first office to a geographical location of a home of the customer; a closeness of the geographical location of the first office to a geographical location of a home of the customer; a closeness of the geographical location of the first office to a geographical location of a work place of the customer; a least amount of expected traffic at the first office, relative to expected traffic at the plurality of offices; and a least amount of scheduled meeting reservations for the first specialist, relative to the amount of scheduled reservations for the one or more specialists.

For example, the customer 150 may normally visit Office 1 to change the named beneficiaries for an account on the first business day after a new family member of the customer 150 is born. After the system has determined that a new family member of the customer 150 is born, the system may identify Specialist A, Specialist D, and Specialist G as having expertise in changing named beneficiaries for an account, and compare the office information of Office 1, Office 3, and Office 4 with calendar information received from the customer 150. The system may determine that although Office 1 is closes to the home of the customer 150, Office 4 is closer to the work site of the customer 150 and is estimated to have significantly less traffic than Office 1 on the expected day of the customer's 150 visit, based on a historical volume of traffic for Office 1 and Office 4. Therefore, the system may display a notification on the computing device of the customer 150, indicating that the customer can reserve a meeting time for with Specialist G at Office 4, and indicating that this meeting time and place will ultimately save the customer 150 time relative to the customer's 150 expected visit to Office 1.

In this manner, the system can better accommodate the time and business needs of customers like customer 150 and specialists of the entity to more efficiently schedule meeting dates and times. Such a process allows the entity to shift a high traffic burden from one office to another office, to provide a customer with more efficient service, and to provide a customer and specialist with a convenient method for scheduling a meeting. Additionally, the system can push information and data associated with the customer and the customer's need to the selected specialist such that the specialist is presented with the appropriate information for assisting the customer at or before the time of the reserved meeting.

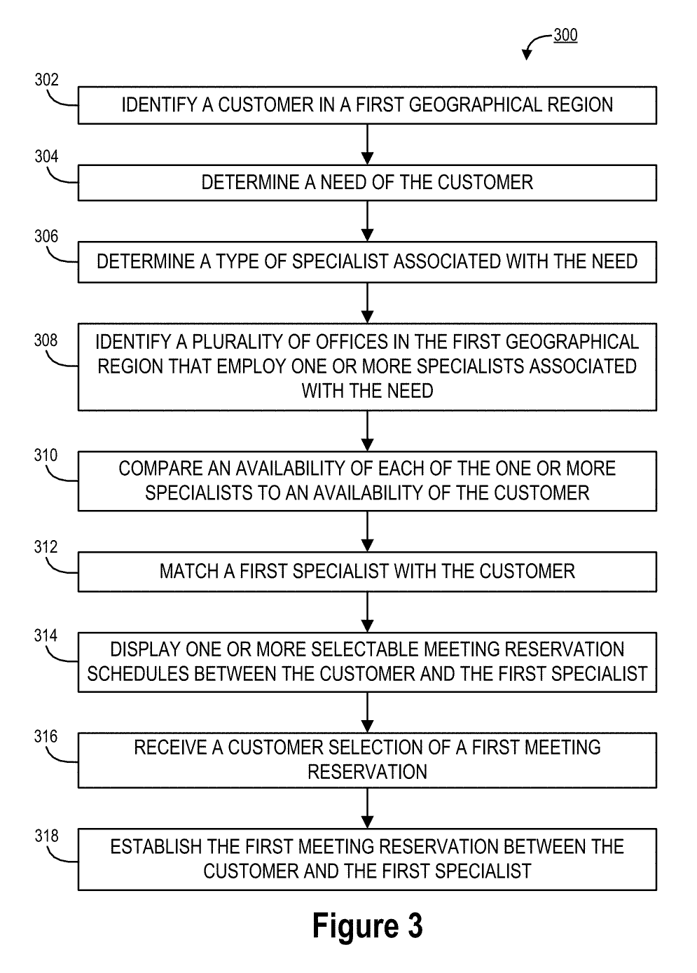

Turning now to FIG. 3, a general process flow 300 is provided for reconciling work flow schedules of a customer and representatives and for pushing data to a specific representative. The process 300 includes the block 302 of identifying a customer in a first geographical region. In some embodiments, the customer is a customer or potential customer of the entity. The customer may be identified from a customer or client list maintained by the entity, from a customer database managed by the entity, and the like. In some embodiments, the entity may identify the customer through a communication between the customer and the entity. For example, the customer may access a website or mobile application of the entity. In some embodiments. For example, the entity may contact or receive a contact request from the customer via a phone call, an electronic mail service, a texting service, and the like.

The process 300 may also include block 304, where the system determines a need of the customer. As used herein, a “need” of a customer is any specific good or service required or desired by a customer that is associated with the entity. A need typically can be resolved or addressed through a meeting with a specialist of the entity. For example, a customer may have a need of updating an account with the entity that requires meeting with an account specialist at an office of the entity to discuss options for updating the account, for authorizing the update of the account, and the like. In some embodiments, a need of a customer is a status check or other routine meeting with a specialist of the entity to discuss the customer's association with the entity. For example, a customer may visit an office of the entity every four months to speak with a specialist about how assets of the customer that are managed by the entity are doing.

In some embodiments, the entity is a financial institution and the offices are branches of the financial institution. In such embodiments, the customer may be a customer of the financial institution, whereby the customer is authorized to visit a plurality of branches to handle needs related to the financial institution. Examples of financial-institution related needs include, but are not limited to, seeking financial advice, applying for a loan, applying for a mortgage, refinancing a loan or mortgage, making a deposit, making a withdrawal, requesting financial account information, updating account information, transferring funds between accounts, paying bills, managing an investment portfolio, learning about new products or services, and the like.

In some embodiments, the system determines the need of the customer by receiving a request or notification from the customer concerning a certain need. This request or notification may be in the form of a call, a short message service (SMS) text, an email, a message via an online customer interface (e.g., a via a website or an application of the entity), a physical visit by the customer to an office of the entity, and the like. In such embodiments, the customer may communicate the need to the entity without being prompted. However, in some embodiments, the entity may request the customer to answer a questionnaire, provide a reason for visiting an office or calling the entity, and the like. In some such embodiments, the entity may prompt an electronic device associated with the customer provide a list of selectable text or icons that represent common or predicted needs of the customer. For example, in embodiments where the entity is a financial institution, the financial institution may prompt a mobile device of one of its customers to display a list of icons representing the needs of depositing a check, withdrawing funds from an account, managing investment assets, and learning about new products or services. The customer may select the icon representing learning about new products or services, which initiates a communication between the customer's mobile device to the system of the financial institution that indicates which need has been selected by the customer. This allows the system of the financial institution to determine which need of the customer needs to be addressed.

In some embodiments, the system determines the need of the customer by reviewing customer information associated with the customer and predicting a need of the customer. Customer information may be any information useful to the entity in identifying a customer, identifying the needs of a customer, predicting the needs of a customer, addressing the needs of a customer, and the like. Customer information for a particular customer includes, but is not limited to, scheduling information of the customer (e.g., a shared calendar, work hours of the customer, free time of the customer, appointments of the customer, and the like), a transaction history of the customer, financial accounts of the customer, customer habits (e.g., common dates and times for the customer to visit offices of the entity, common interactions between the customer and specialists of the entity), a geographical location of the customer (e.g., global positioning system (GPS) information, mobile device information, and the like), a search history of the customer, and the like. The system may also review interactions of the customer with the entity's website, such as beginning to fill out a loan application, to determine what the need of the customer is.

For example, the system may receive network data from searches by the customer indicating that the customer is searching for a new home, a law firm, a real estate agent, mortgage or loan calculators, or the like, which indicates that the customer may be buying a new home and therefore has a need of a loan.

In some embodiments, the system reviews the transaction history, financial accounts of the customer, and customer habits of the customer to determine a pattern in the customer's historical needs. For example, the system may determine from the transaction and account information that the customer updates an investment portfolio associated with the customer at a first time period every year (e.g., during the same month, week, day of each year). As such, the system may predict that the customer will have the same need during the next such first time period (e.g., during the same month, week, day of the next year).

In another example, in embodiments where the entity is a financial institution, the system may analyze the transaction history of the customer to determine that the customer withdraws a cashier's check on the first day of each month (or the first business day of each month). As such, the system may predict that the customer will have the same need on the first day of the next month.

In some embodiments, the system may predict a need of a customer based on upcoming deadlines or expirations related to financial accounts and/or financial assets of the customer. For example, a financial institution may analyze financial account information and investment information of a customer to determine that a certificate of deposit (CD) is approaching its maturity date. The system may predict that the customer will have a need related to the management of the CD, or the reinvestment of funds associated with the CD at some point prior to, on, or after the maturity date of the CD. As such, the system may predict a need of a customer without receiving any input from the customer.

In some embodiments, the process 300 includes block 306, where the system determines a type of specialist associated with the need. As mentioned before, the entity may have a plurality of specialists, wherein each specialist is an expert in addressing one or more needs of customers. Of course, multiple specialists may have expertise in the same need, and a single specialist may have expertise in multiple needs. Each type of specialist is associated with one or more related customer needs. For example, if the entity is a financial institution, then a first type of specialist may have expertise in assisting a customer in withdrawing funds from an account and depositing funds into an account. Therefore, any customer that has a determined or predicted need of withdrawing funds or depositing funds can be matched with a first type of specialist by the system. Continuing the example, a second type of specialist may be associated with long-term investment strategies, a third type of specialist may be associated with short-term investment strategies, a fourth type of specialist may be associated with managing financial account ownership and organization, a fifth type of specialist may be associated with new financial products, and the like.

In some embodiments, the entity may keep records of which specialists are associated with which types of specialist, and may store this information in a database such as the datastore 117 referenced in FIG. 1. Upon determining the need of the customer, the system can match the need of the customer to the respective type of specialist in the database.

The process 300 may also include block 308, where the system identifies a plurality of offices in the first geographical region that employ one or more specialists associated with the need. As discussed in reference to FIG. 2, an entity may have multiple offices in a geographical region, with each office having one or more specialists employed by, or otherwise associated with, the office. The system may analyze certain office information to determine which offices employ the certain type of specialist needed to address the need of the customer.

Office information is any information that assists the system in identifying which offices of the entity employ, or are associated with, one or more of the specialists that are the type of specialist associated with a need. Office information includes, but is not limited to, a list of one or more specialists at each office, a calendar for scheduling appointments for each of the one or more specialists at each office, historical traffic information for each of the plurality of offices (e.g., volume of transactions, average wait times for meetings, median wait times for meetings, number of customer interactions, and the like over one or more time periods), hours of operation for each of the plurality of offices, geographical location information for each of the plurality of offices, and the like.

In some embodiments, office information is stored in a database, such as the datastore 117 of the entity system 110 and/or the datastore 127 of the specialist device system 120, as described with respect to FIG. 1. In some such embodiments, after identifying the type of specialist needed by the customer to address the determined or predicted need, the system may analyze the office information from the database to determine which offices employ or otherwise are associated with one or more specialists with expertise related to the need.

In some embodiments, the process 300 includes block 310, where the system compares an availability of each of the one or more specialists to an availability of the customer. Comparing the availability of specialists to the customer may involve analyzing customer information and office information, particularly the calendar of the customer, a predicted date and/or time for the customer to have the need, the calendars of specialists associated with the need of the customer, traffic (or expected traffic) of each office associated with the one or more specialists, and the like. In such embodiments, the system is able to compare the availabilities of the customer and each of the specialists to identify a plurality of dates and times that likely are

Furthermore, the process 300 may include block 312, where the system matches a first specialist with the customer. In some embodiments, the system matches the customer with the first specialist by determining that the first specialist has the appropriate expertise to address the need of the customer (i.e., the first specialist is the type of specialist associated with the need). Additionally, the system matches the customer with the first specialist by determining that the customer and the first specialist share at least one available date and time for a potential meeting. In some embodiments, the system matches the customer with the first specialist at least partially because the first specialist has the first available, matching meeting time slot to meet with the customer.

Other factors may be used by the system to determine which specialist to match with the customer. For example, the system may analyze geographical data associated with the customer and the offices of available specialists to determine which office is closest to the customer. In such embodiments, the system may analyze location data of the customer to determine a location or region associated with the customer. In some embodiments, the customer has a customer device, like the one used in customer device system 140 referenced in FIG. 1. The system may communicate with a GPS application 146 on the mobile device of the customer, like GPS Application 146 to determine the location of the customer.

In some embodiments, at least one of the factors used by the system in matching the first specialist to the customer is a closeness of a geographical location of office of the first specialist and a current geographical location of the customer. In such embodiments, the system may identify the current location of the customer through input from the customer or by determining a location of the GPS application of a mobile device of the customer.

Additionally, at least one of the factors used by the system in matching the first specialist to the customer may be a closeness of the geographical location of the office of the first specialist and a home location of the customer. In such embodiments, the system may identify the home location of the customer through input from the customer or through determining a common location of the GPS application of the mobile device of the customer during evening or night hours.

In some embodiments, at least one of the factors used by the system in matching the first specialist to the customer is a closeness of the geographical location of the office of the first specialist and a work location of the customer. In such embodiments, the system may identify the work location of the customer through input from the customer or through determining a common location of the GPS application of the mobile device of the customer during work hours.

The system may also access a customer calendar application to identify a location that the customer will be in at a date and time in the future. This future location of the customer may be used as a factor in matching the first specialist to the customer. For example, the system may identify from the customer calendar application that the customer will be in a city away from the customer's home location in five days, and therefore may match the customer with a specialist in that other city for a meeting in five days.

In some embodiments, at least one of the factors used by the system in matching the first specialist to the customer is the amount of expected traffic at the office of the first specialist at potential meeting times with the customer, relative to the expected traffic at other offices of the entity. For example, the system may determine that the office of the first specialist will have the least amount of traffic of all of the offices of the entity within a certain geographical area. In this way, the system may enable the entity to spread the work load for the entity more evenly across its multiple offices.

Furthermore, at least one of the factors used by the system in matching the first specialist to the customer may be the amount of scheduled reservations for the first specialist, relative to the amount of scheduled reservations for the other specialists of the entity that are capable of addressing the customer's needs. In this way, the system enables the entity to spread the work load for the entity more evenly across its multiple specialists.

The system may also allow the customer to notify the system that the customer is on the way to an office of the entity. The system may have established an electronic communication channel with the customer device, and prompted a user interface of the customer device to display a selectable option of “I am on my way” to an indicated office, which the customer may select. Once the customer has selected this option, the system may receive the notification and begin to match the customer with one or more specialists at the indicated office, based on the first available specialist. In some embodiments, the system may also access the GPS application of the customer device system to determine how far away the customer is from the indicated branch. The system can then determine a time that it is expected for the customer to take to get to the indicated office, and begin matching the customer with specialists that are available after that time.

In some embodiments of the invention, the process 300 includes block 314, where the system displays one or more selectable meeting reservation schedules between the customer and the first specialist. In some embodiments, the system displays the selectable meeting reservations on a kiosk or other display at an office location of the entity. For example, in embodiments where the entity is a financial institution, the system may present the selectable meeting reservations on an automatic teller machine (ATM) or other digital display to the customer. In some embodiments, the system may communicate with a mobile device of the customer, prompting the mobile device to display the selectable meeting reservations to the customer.

The selectable meeting reservations may be names, icons, descriptions, or the like that represent available meeting reservation dates and times. In some embodiments, the selectable meeting reservations may be overlaid on a calendar display such that the customer may more easily identify the dates and times of the available meeting reservations with the first specialist. The selectable meeting reservations may be for different times and/or dates, such that the customer has multiple options for deciding when to schedule the meeting with a specialist. In some embodiments, multiple specialists are represented in the selectable meeting reservations. For example, a first selectable meeting reservation may be for a first specialist, while second and third meeting reservations are associated with a second specialist. These specialists may be from the same or different offices of the entity.

In some embodiments, one or more of the selectable meeting reservations may be associated with dates that are different from when the customer normally addresses the need. For example, the customer may normally address the need on the first business day of every month. However, the system may have determined that the offices of the entity normally have higher-than-average traffic on the first day of every month, but have lower-than-average traffic on the second business day of each month. Therefore, at least one of the selectable meeting reservations may be for a meeting date and time one the second business of the next month. In this manner, the system may spread the workload of the entity around such that one or more offices are not excessively busy on one day and excessively slow on another day.

The process 300 may also include block 316, where the system receives a customer selection of a first meeting reservation. In some embodiments, the customer may select one of the selectable meeting reservations on the mobile device of the customer. The mobile device may communicate the customer selection to the system.

The process 300 may additionally include block 318, where the system establishes the first meeting reservation between the customer and the first specialist at the office of the first specialist. Establishing the first meeting reservation may comprise reserving the time, date, and location for a meeting between the customer and the first specialist at the office of the first specialist such that the first specialist may assist the customer in addressing the need. In some embodiments, establishing the first meeting includes reserving a physical room at the office of the first specialist. However, in other embodiments, the system may reserve a date and time for the customer and the first specialist to communicate via an online interface, a phone call, text message, video conference, and the like.

In some embodiments, the system may prompt a customer calendar application of the mobile device of the customer to save, mark, or otherwise denote that a meeting has been scheduled between the customer and the first specialist. In some embodiments, the customer calendar application is also prompted to save and/or display a location of the meeting, or if no location is necessary (e.g., for a teleconference call), logistical information for communicating with the first specialist at the date and time of the scheduled meeting reservation. The customer calendar application may also be prompted to display information related to the need of the customer, other customer information (e.g., account information, transaction history, and the like), products and/or services of the entity, information about the first specialist, alternative reservation dates and times (in case the customer needs to reschedule the meeting), and the like. In some embodiments, the customer calendar application of the customer's mobile device is substantially similar to the customer calendar application 145 of the customer device system 140 referenced in FIG. 1.

Likewise, the system may prompt a specialist calendar application 125 of a device associated with the first specialist to save, mark, or otherwise denote that a meeting has been scheduled between the customer and the first specialist. In some embodiments, the specialist calendar application 125 is also prompted to save and/or display information associated with the need of the customer before and/or at the date and time of the selected first meeting reservation with the customer. In some embodiments, at least some information displayed by the specialist calendar application 125 is different from information displayed by the customer calendar application 145, such that the specialist 130 has all necessary information to address the need of the customer without providing an overwhelming amount of information or proprietary information to the customer. The information displayed to the first specialist by the specialist customer application may comprise the customer information, the need of the customer, documents and/or forms associated with the need of the customer, notes from previous meetings with the customer, and the like. In this way, the system conveniently provides the first specialist with enough information to address the need of the customer without requiring the specialist to search for the information separately.

Additionally, the system may communicate with a device of the customer to inform the customer of items to bring to the meeting, tasks to complete before the meeting, a summary of what to expect during the meeting with the specialist, questions to ask the specialist, answers to prepare before meeting with the specialist, and the like. In this manner, the system aids the customer in being prepared for the meeting with the specialist, which improves the effectiveness of the specialist in addressing the need of the customer.

While parts of the present invention have been described with respect to a single customer being matched with a single specialist, it should be noted that multiple customers may be matched with a specialist for a scheduled meeting. For example, two or more customers may have a need of creating a joint financial account. The system may then access customer calendar applications for each of the two or more customers to identify dates and times in which all of the customers are available at the same time. The system can then match the customers with a specialist for assisting the customers in creating the joint banking account.

Similarly, multiple specialists may be needed to address the need of one or more customers. For example, a customer may have a complex need that involves two distinct aspects of the business of the entity (e.g., corporate financial accounts and real estate loans). The system may therefore match the customer with a specialist from both aspects of the business. In some embodiments, the system may set up two meetings, one for each specialist, that may or may not be at the same location. In other embodiments, the system may match the customer and the specialists with meeting reservations that are available for all three individuals.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with communicating with several databases and computing device systems to schedule meetings between customers and specialists of an entity.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for communicating with several databases and computing device systems to schedule meetings between customers and specialists of an entity, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Application | | |
|---|---|---|---|
| Docket Number | Ser. No. | Title | Filed On |
| 6952US1.014033.2574 | To be assigned | MOBILE APPLICATION | Concurrently |
| | | CONFIGURATION BASED ON | herewith |
| | | GEOGRAPHIC AND | |
| | | TRANSACTION HISTORY | |
| | | CONTEXT | |
| 6957US1.014033.2576 | To be assigned | MALFEASANCE DETECTION | Concurrently |
| | | BASED ON IDENTIFICATION | herewith |
| | | OF DEVICE SIGNATURE | |
| 6956US1.014033.2577 | To be assigned | RECURRING EVENT | Concurrently |
| | | ANALYSES AND DATA PUSH | herewith |
| 6953US1.014033.2578 | To be assigned | ALTERNATIVE CHANNEL | Concurrently |
| | | SELECTION BASED ON | herewith |
| | | PREDICTIVE WORK FLOW | |

What is claimed is:

1. A system for work flow schedule reconciliation and data push for an entity, said system comprising:
one or more memory devices having computer readable program code stored thereon;
a communication device; and
one or more processing devices operatively coupled to the one or more memory devices, wherein the one or more processing devices are configured to execute the computer readable program code to:
identify a customer in a first geographical region;
determine a need of the customer based on customer information stored in a customer information database;
determine a type of specialist associated with the need;
identify a plurality of offices in the first geographical region that employ one or more specialists of the type of specialist associated with the need based on office information stored in an office information database;
compare an availability of each of the one or more specialists to an availability of the customer;
match a first specialist of the one or more specialists with the customer;
prompt a mobile device of the customer to display one or more selectable meeting reservation schedules between the customer and the first specialist;
receive, from the mobile device of the customer, an indication that the customer selected a first meeting reservation of the one or more selectable meeting reservation schedules; and
establish the first meeting reservation between the customer and the first specialist at a first office of the plurality of offices that is associated with the first specialist.

2. The system of claim 1, wherein the need of the customer is normally addressed by the customer on a first day of the week; and
wherein the first meeting reservation is for a second day of the week.

3. The system of claim 1, wherein matching the first specialist comprises matching the customer to the first specialist based on at least one of the following factors:
a closeness of a geographical location of the first office to a current geographical location of the customer;
a closeness of the geographical location of the first office to a geographical location of a home of the customer;
a closeness of the geographical location of the first office to a geographical location of a work place of the customer;
a least amount of expected traffic at the first office, relative to expected traffic at the plurality of offices; and
a least amount of scheduled meeting reservations for the first specialist, relative to the amount of scheduled reservations for the one or more specialists.

4. The system of claim 1, wherein the customer information comprises at least one of the following:
a calendar for scheduling appointments of the customer;
transaction history of the customer;
financial accounts of the customer;
customer habits comprising:
common dates and times for the customer to visit the plurality of offices;
common interactions between the customer and the one or more specialists;
a geographical location of the customer;
a geographical location of a home of the customer; and
a geographical location of a work site of the customer.

5. The system of claim 1, wherein the office information comprises at least one of the following:
a list of the one or more specialists;
a calendar for scheduling appointments for each of the one or more specialists;
historical traffic for each of the plurality of offices;
hours of operation for each of the plurality of offices; and
a geographical location of each of the plurality of offices.

6. The system of claim 1, wherein the one or more processing devices are configured to execute the computer readable program code to prompt a specialist device to display information associated with the need at a time and date associated with the first reservation.

7. The system of claim 6, wherein the information associated with the need of the customer comprises at least one of the following:
the customer information;
the need of the customer; and
a document associated with the need of the customer.

8. A computer program product for work flow schedule reconciliation and data push for an entity, the computer program product comprising at least one non-transitory computer readable medium comprising computer readable instructions, the instructions comprising instructions for:
identifying a customer in a first geographical region;
determining a need of the customer based on customer information stored in a customer information database;
determining a type of specialist associated with the need;
identifying a plurality of offices in the first geographical region that employ one or more specialists of the type of specialist associated with the need based on office information stored in an office information database;
comparing an availability of each of the one or more specialists to an availability of the customer;
matching a first specialist of the one or more specialists with the customer;
prompting a mobile device of the customer to display one or more selectable meeting reservation schedules between the customer and the first specialist;
receiving, from the mobile device of the customer, an indication that the customer selected a first meeting reservation of the one or more selectable meeting reservation schedules; and
establishing the first meeting reservation between the customer and the first specialist at a first office of the plurality of offices that is associated with the first specialist.

9. The computer program product of claim 8, wherein the need of the customer is normally addressed by the customer on a first day of the week; and
wherein the first meeting reservation is for a second day of the week.

10. The computer program product of claim 8, wherein matching the first specialist comprises matching the customer to the first specialist based on at least one of the following factors:
a closeness of a geographical location of the first office to a current geographical location of the customer;
a closeness of the geographical location of the first office to a geographical location of a home of the customer;
a closeness of the geographical location of the first office to a geographical location of a work place of the customer;
a least amount of expected traffic at the first office, relative to expected traffic at the plurality of offices; and
a least amount of scheduled meeting reservations for the first specialist, relative to the amount of scheduled reservations for the one or more specialists.

11. The computer program product of claim 8, wherein the customer information comprises at least one of the following:
a calendar for scheduling appointments of the customer;
transaction history of the customer;
financial accounts of the customer;
customer habits comprising:
common dates and times for the customer to visit the plurality of offices;
common interactions between the customer and the one or more specialists;
a geographical location of the customer;
a geographical location of a home of the customer; and
a geographical location of a work site of the customer.

12. The computer program product of claim 8, wherein the office information comprises at least one of the following:
a list of the one or more specialists;
a calendar for scheduling appointments for each of the one or more specialists;
historical traffic for each of the plurality of offices;
hours of operation for each of the plurality of offices; and
a geographical location of each of the plurality of offices.

13. The computer program product of claim 8, wherein the computer readable instructions further comprise instructions for prompting a specialist device to display information associated with the need at a time and date associated with the first reservation.

14. The computer program product of claim 13, wherein the information associated with the need of the customer comprises at least one of the following:
the customer information;
the need of the customer; and
a document associated with the need of the customer.

15. A computer implemented method for work flow schedule reconciliation and data push for an entity, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying a customer in a first geographical region;
determining a need of the customer based on customer information stored in a customer information database;
determining a type of specialist associated with the need;
identifying a plurality of offices in the first geographical region that employ one or more specialists of the type of specialist associated with the need based on office information stored in an office information database;
comparing an availability of each of the one or more specialists to an availability of the customer;
matching a first specialist of the one or more specialists with the customer;
prompting a mobile device of the customer to display one or more selectable meeting reservation schedules between the customer and the first specialist;
receiving, from the mobile device of the customer, an indication that the customer selected a first meeting reservation of the one or more selectable meeting reservation schedules; and
establishing the first meeting reservation between the customer and the first specialist at a first office of the plurality of offices that is associated with the first specialist.

16. The computer implemented method of claim 15, wherein the need of the customer is normally addressed by the customer on a first day of the week; and
wherein the first meeting reservation is for a second day of the week.

17. The computer implemented method of claim 15, wherein matching the first specialist comprises matching the customer to the first specialist based on at least one of the following factors:
a closeness of a geographical location of the first office to a current geographical location of the customer;
a closeness of the geographical location of the first office to a geographical location of a home of the customer;
a closeness of the geographical location of the first office to a geographical location of a work place of the customer;
a least amount of expected traffic at the first office, relative to expected traffic at the plurality of offices; and
a least amount of scheduled meeting reservations for the first specialist, relative to the amount of scheduled reservations for the one or more specialists.

18. The computer implemented method of claim 15, wherein the customer information comprises at least one of the following:
a calendar for scheduling appointments of the customer;
transaction history of the customer;
financial accounts of the customer;
customer habits comprising:
common dates and times for the customer to visit the plurality of offices;
common interactions between the customer and the one or more specialists;
a geographical location of the customer;
a geographical location of a home of the customer; and
a geographical location of a work site of the customer.

19. The computer implemented method of claim 15, wherein the office information comprises at least one of the following:
a list of the one or more specialists;
a calendar for scheduling appointments for each of the one or more specialists;
historical traffic for each of the plurality of offices;
hours of operation for each of the plurality of offices; and
a geographical location of each of the plurality of offices.

20. The computer implemented method of claim 15, further comprising prompting a specialist device to display information associated with the need at a time and date associated with the first reservation, wherein the information associated with the need of the customer comprises at least one of the following:
the customer information;
the need of the customer; and
a document associated with the need of the customer.
